(19) United States
(12) Patent Application Publication
(10) Pub. No.: US 2007/0254684 A1
(43) Pub. Date: Nov. 1, 2007

(54) Method and system for sending and creating expressive messages

(75) Inventor: John Yue Jun Jiang, Danville, CA (US)

Correspondence Address: ARENT FOX PLLC, 1050 CONNECTICUT AVENUE, N.W., SUITE 400, WASHINGTON, DC, 20036, US

(73) Assignee: ROAMWARE, INC.

(21) Appl. No.: 11/708,679

(22) Filed: Feb. 21, 2007

Related U.S. Application Data
(63) Continuation-in-part of application No. 11/503,301, filed on Aug. 14, 2006.
Application No. 11/503,301 is a continuation of application No. 09/932,439, filed on Aug. 16, 2001, now Pat. No. 7,092,370.
(60) Provisional application No. 60/774,671, filed on Feb. 21, 2006.

(51) Int. Cl. H04Q 7/20

(52) U.S. Cl. 455/466

(57) ABSTRACT

A method and system for creating and sending expressive messages is provided. The method includes receiving (202) a text message, where the text message is sent from a first communication device (102) to a second communication device (104). Further, the method includes transforming (204) the text message into an expressive message and directing (206) the expressive message to the second communication device.

### RELATED APPLICATIONS

This application claims priority to U.S. Provisional Patent Application Ser. No. 60/774,671, entitled “Expressive SMS,” filed on Feb. 21, 2006 and is also a continuation-in-part of U.S. application Ser. No. 11/503,301, entitled “Method and System for Wireless Voice Channel/Data Channel Integration,” filed on Aug. 14, 2006, which in turn is a continuation of U.S. application Ser. No. 09/932,439, filed on Aug. 16, 2001, now U.S. Pat. No. 7,092,370, the entire contents of which are incorporated herein by reference in their entirety.

### BACKGROUND OF THE INVENTION

The present invention relates to the field of communication devices, and more particularly, to a method and system for creating and sending expressive messages through communication devices.

The explosive growth of the cell phone industry over the past several years has forced communication device manufacturers and mobile operators continually to offer new and improved services with each generation of new communication devices, and new services to differentiate themselves from ever-increasing forms of competition. Examples of communication devices and services include mobile phones, Voice over Internet Protocol (VoIP) phones, wireless phones, wired phones, landline phones, cordless phones, satellite phones, semi-cordless phones and the like. New services such as call waiting, caller ID, three-way calling, call forwarding, and voice dialing have become standard in the newer generation communication devices. Likewise, Short Messaging Service (SMS) has always been a very popular source of communication. People are very comfortable with sending SMS messages and very familiar with the user interface on the handsets. Multimedia Messaging Service (MMS) popularity, on the other hand, is still very limited. This can be attributed to several reasons like MMS configuration on the handsets, GPRS subscription, MMS subscription, MMS capable handsets, MMS configuration on the handsets, unfamiliar user interface for the usage of MMS, and the like.

In a rush to increase MMS usage, many innovative applications have been created. A notable one is the Color SMS application that converts SMS message to a MMS message by applying a rich media color to the sender's SMS message. By analyzing the keywords and meaning in the SMS message as well as historical data and environment context (For example season, time of day), a color or multimedia mix is selected and combined with the SMS text to produce a final MMS message for the recipient. The application is important because it combines the familiar user experience of SMS with MMS so to increase the MMS usage and hence the data service.

However this service still does not address problem of receiving MMS capable handsets, MMS configuration on the handsets, GPRS subscription, MMS subscription, and the like. All these factors have contributed to the poor usage of the service. Furthermore, when the user enters a long SMS text, it could cloud the eventual MMS picture message.

In the present scenario, there is a need for a system, which can address the limitation of MMS service being limited to MMS capable handsets. Thus, there is a need for expressive messages, which can serve the purpose of MMS without being limited to MMS capable handsets. An expressive message is a message that contains multimedia content. Also, there is a need for a system in which a SMS message can be sent to a handset not capable of receiving SMS messages.

### BRIEF DESCRIPTION OF THE DRAWINGS

FIG. 1 illustrates an exemplary environment in which various embodiments of the present invention can be practiced.

FIG. 2 is a flowchart illustrating a method for creating and sending an expressive message, in accordance with an embodiment of the present invention.

FIG. 3 is a flowchart illustrating a method for creating and sending an expressive message, in accordance with another embodiment of the present invention.

FIG. 4 is a block diagram illustrating a system for creating and sending an expressive message, in accordance with an embodiment of the present invention.

FIG. 5 is a block diagram illustrating a system for creating and sending an expressive message, in accordance with another embodiment of the present invention.

FIG. 6 is sample architecture of the system for creating and sending an expressive message, in accordance with an embodiment of the present invention.

FIG. 7 is sample screen of a portal for personalizing the multimedia content of an expressive message, in accordance with an embodiment of the present invention.

FIG. 8 is sample flow of call for creating and sending an expressive message, in accordance with an embodiment of the present invention.

FIG. 9 is sample ecosystem architecture of the system for creating and sending an expressive message, in accordance with an embodiment of the present invention.

FIG. 10 and FIG. 11 is an example for creating and sending an expressive message from a first communication device to a second communication device, in accordance with an embodiment of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### SUMMARY OF THE INVENTION

The present invention discloses a method and a system for creating and sending expressive messages. An expressive message is a telecommunicated message that contains multimedia content. The expressive message can serve the purpose of MMS message without requiring an MMS capable handset to receive it.

In accordance with an embodiment of the present invention, the method includes receiving a text message, where the text message is sent from a first communication device to a second communication device. The method further includes transforming the text message into an expressive message. Finally, the expressive message is directed to the second communication device.

In accordance with an embodiment of the present invention, the system for creating and sending expressive messages includes a reception module for receiving a text message, where the text message is sent from a first communication device to a second communication device. The system further includes a transformation module for transforming the text message into an expressive message. Further, the system includes a direction module for directing the expressive message to the second communication device.

### DETAILED DESCRIPTION OF THE DRAWINGS

Before describing in detail the particular method and system for creating and sending expressive messages in accordance with the present invention, it should be observed that the present invention resides primarily in combinations of method steps and system components related to creating and sending the expressive messages.

Accordingly, the system components and method steps have been represented where appropriate by conventional symbols in the drawings, showing only those specific details that are pertinent to understanding the present invention so as not to obscure the disclosure with details that will be readily apparent to those of ordinary skill in the art having the benefit of the description herein.

In this document, relational terms such as ‘first’ and ‘second’, and the like may be used solely to distinguish one entity or action from another entity or action without necessarily requiring or implying any actual such relationship or order between such entities or actions. The terms ‘comprises’, ‘comprising’, or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by ‘comprises . . . a’ does not, without more constraints, preclude the existence of additional identical elements in the process, method, article, or apparatus that comprises the element.

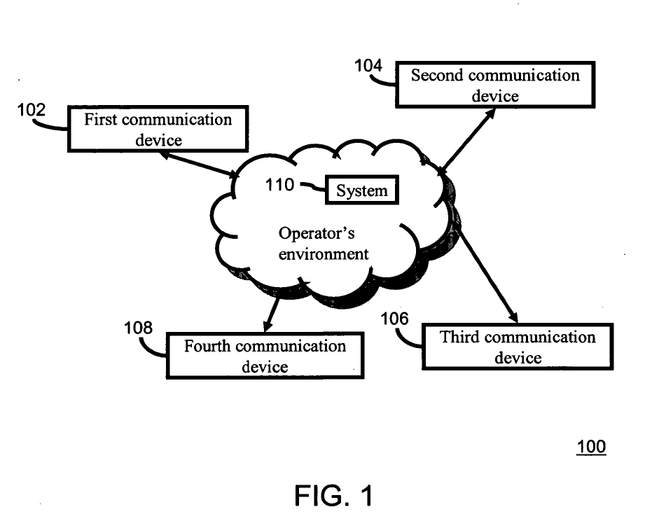

FIG. 1 illustrates an exemplary environment in which various embodiments of the present invention can be practiced. The environment includes a first communication device 102, a second communication device 104, a third communication device 106 and a fourth communication device 108. Examples of communication devices 102, 104, 106 and 108 include mobile phones, Voice over Internet Protocol (VoIP) phones, wireless phones, wired phones, landline phones, cordless phones, satellite phones, semi-cordless phones and the like. The communication devices 102, 104, 106 and 108 are capable of supporting one or more telephone communication technologies. Examples of the wireless telephones in this set of technologies include 2G technology, 2.5G technology, 3G technology, 4G technology and the like. The environment also includes the communication devices 102, 104, 106 and 108 communicating over an operator environment 100. Examples of the operator environment 100 include mobile telephone operators, fixed line POTS (Plain Old Telephone Service) carriers, VOIP providers and others who provide widely accessible telecommunications services like telephony and data communications. Examples of such telephone companies include Verizon, AT&T, Telstra, Orange, Vodafone, Vonage and the like. The environment also includes a system 110 for creating and sending expressive messages. The system 110 can be hosted in the operator environment 100, in non-operator ecosystem maintained or managed by a service provider for interconnection with operators, or directly in the operator environment 100 or in the operator environment and connected to such an ecosystem. In the present embodiment, the system 110 is hosted in the operator environment 100. In present embodiment, the first communication device 102 sends a message to the second communication device 104.

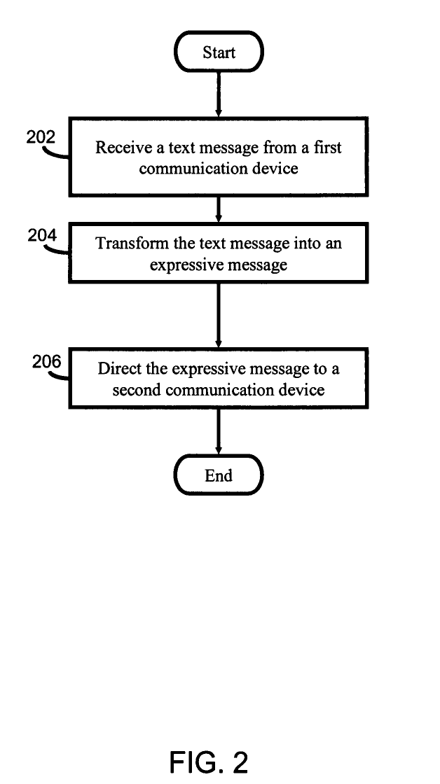

FIG. 2 is a flowchart illustrating a method for creating and sending an expressive message, in accordance with an embodiment of the present invention. At step 202, a text message is received, where the first communication device 102 sends the text message. The text message is received for delivering the text message to the second communication device 104. At step 204, the text message is transformed into an expressive message. An expressive message is a message containing multimedia content. Further at step 206, the expressive message is directed to the second communication device 104.

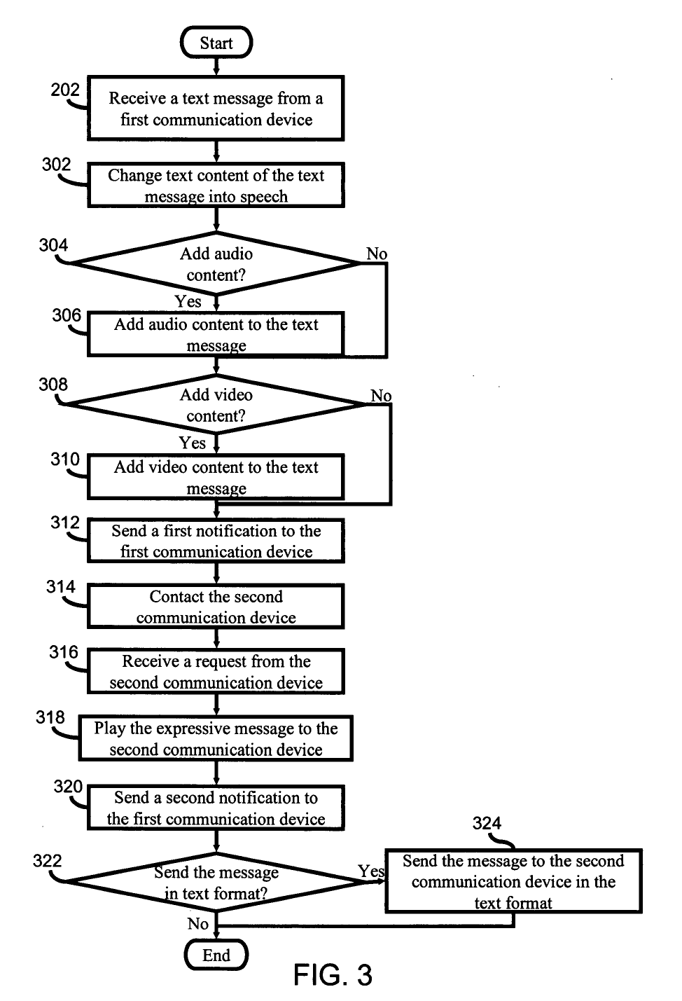

FIG. 3 is a flowchart illustrating a method for creating and sending an expressive message, in accordance with another embodiment of the present invention. At step 202, a text message is received, where the first communication device 102 sends the text message. At step 302, the text content of the text message is changed into a widely-communicable media form, such as audible speech. In an embodiment of the present invention, the text message is converted into speech automatically. In another embodiment of the present invention, the text message is converted into speech based on the instructions given by the first communication device 102. That text message converted into audible speech is an example of an expressive message under the present invention. Also, the speech of the expressive message can be spoken through a pre-specified voice or through a voice chosen automatically. In the present embodiment, the voice to be added is chosen automatically, using keyword recognition, where the keywords are selected from the text contained in the text message. In another embodiment of the present invention, the pre-specified voice to be added is chosen by the first communication device 102 through a set of instructions.

At step 304, the system checks if other audio content should be added to the text message that has been converted into speech. In an embodiment of the present invention, audio content is added to the expressive message at step 306. Examples of that other audio content include music background, varied sounds, sound effects and the like. In the present embodiment, the audio content to be added is chosen automatically, using keyword recognition, where the keywords are selected from the text contained in the text message. In another embodiment of the present invention, the audio content to be added is chosen by the first communication device 102 through a set of instructions. In another embodiment of the present invention, audio content is not added to the expressive message.

At step 308, the system checks if video content should be added to the expressive message. In an embodiment of the present invention, video content is added to the expressive message at step 310. Examples of the video content include video background, audio-visual background, picture, video clip and the like. In the present embodiment, the video content to be added is chosen automatically, using keyword recognition, where the keywords are selected from the text contained in the text message. In another embodiment of the present invention, the video content to be added is chosen by the first communication device 102 through a set of instructions. In another embodiment of the present invention, video content is not added to the expressive message.

At step 312, a first notification is sent to the first communication device 102 informing that the text message has been transformed into an expressive message. At step 314, the second communication device 104 is contacted regarding the delivery of the expressive message. In an embodiment of the present invention, an alert is sent to the second communication device 104. The alert includes information about the expressive message and the procedure to access the expressive message. At step 316, a request is received from the second communication device 104 to access the expressive message. Calling a number pre-specified contained in the alert makes the request. Based on the wireless telephone technology of the second communication device 104, the expressive message is played to the second communication device at step 318. For example, if the second communication device 104 uses 2G technology, the expressive message can be played with audio content added to it and if the second communication device 104 uses 3G technology, the expressive message can be played with video content added to the expressive message.

In another embodiment of the present invention, at step 314 the second communication device 104 is contacted by directly calling the second communication device 104. At step 316, a request is received from the second communication device 104 to access the expressive message. The request is made based on the instructions given during the call. Based on the telephone technology of the second communication device 104, then at step 318 the expressive message is played in a form that the second communication device can convey to the user—whether audible speech only, including audio content, including video content, or including other media forms amenable to the capabilities of that second communications device and the telecommunications system in which it operates.

At step 320, a second notification is sent to the first communication device 102. The second notification is sent to inform the first communication device 102 that the expressive message has been delivered to the second communication device 104. At step 322, it is checked if the expressive message needs to be delivered to the second communication device 104 as the original text message. In an embodiment of the present invention, the message is sent to the second communication device 104 at step 324.

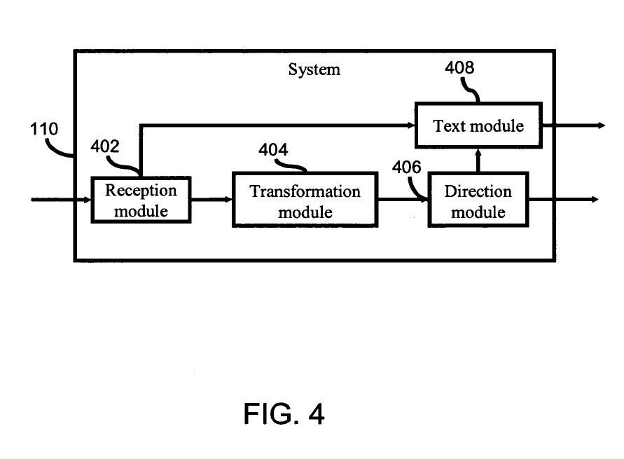

FIG. 4 is a block diagram illustrating a system 110 for creating and sending an expressive message, in accordance with an embodiment of the present invention. The system 110 includes a reception module 402, a transformation module 404, a direction module 406 and a text module 408. The reception module 402 is capable of receiving a text message, where the text message is sent from the first communication device 102 to the second communication device 104. The transformation module 404 transforms the text message into an expressive message. The direction module 406 directs the expressive message to the second communication device 104. The text module delivers the text message to the second communication device 104 in the original format.

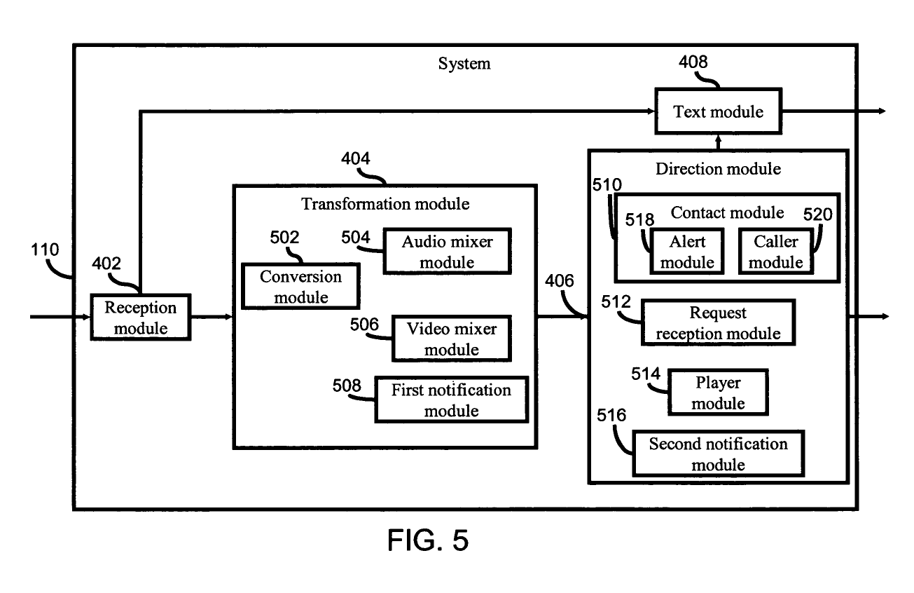

FIG. 5 is a block diagram illustrating a system 110 for creating and sending an expressive message, in accordance with another embodiment of the present invention. The system 110 includes a reception module 402, a transformation module 404, a direction module 406 and a text module 408. The reception module 402 is capable of receiving a text message, where the text message is sent from the first communication device 102 to the second communication device 104. The transformation module 404 transforms the text message into an expressive message. The direction module 406 directs the expressive message to the second communication device 104. The text module delivers the text message to the second communication device 104 in the original format.

The transformation module 404 includes a conversion module 502, an audio mixer module 504, a video mixer module 506 and a first notification module 508. In one aspect of the present invention, the conversion module 502 converts text content of the text message into speech (or another media form other than text). In an embodiment of the present invention, the text message is converted into speech automatically. In another embodiment of the present invention, the text message is converted into speech based on the instructions given by the first communication device 102. Also, the speech of the expressive message can be spoken through a pre-specified voice or through a voice chosen automatically by the conversion module 502. In the present embodiment, the voice to be added is chosen automatically, using keyword recognition, where the keywords are selected from the text contained in the text message. In another embodiment of the present invention, the pre-specified voice to be added is chosen by the first communication device 102 through a set of instructions. The audio mixer module 504 can add audio content to the expressive message. In the present embodiment, the audio content to be added is chosen automatically by the audio conversion module 504, using keyword recognition, where the keywords are selected from the text contained in the text message. In another embodiment of the present invention, the audio content to be added is chosen by the first communication device 102 through a set of instructions. In another embodiment of the present invention, audio content is not added to the expressive message. The video mixer module 506 can add video content to the expressive message. In the present embodiment, the video content to be added is chosen automatically by the video mixed module 506, using keyword recognition, where the keywords are selected from the text contained in the text message. In another embodiment of the present invention, the video content to be added is chosen by the first communication device 102 through a set of instructions. In another embodiment of the present invention, video content is not added to the expressive message. The first notification module 508 sends a notification to the first communication device 102 informing that the text message has been transformed into an expressive message.

The direction module includes a contact module 510, a request reception module 512, a player module 514 and a second notification module 516. The contact module 510 contacts the second communication device 104 regarding the delivery of the expressive message. The contact module further includes an alert module 518 and a caller module 520. The alert module 518 sends an alert to the second communication device 104. The alert includes information about the expressive message and the procedure to access the expressive message. The caller module 520 calls the second communication device 104 directly regarding information about the expressive message. The request reception module 512 receives a request from the second communication device 104 to access the expressive message. The player module 514 plays the expressive message to the second communication device based on the wireless telephone technology of the second communication device 104. The second notification module 516 sends a second notification to the first communication device 102 that the expressive message has been delivered to the second communication device 104.

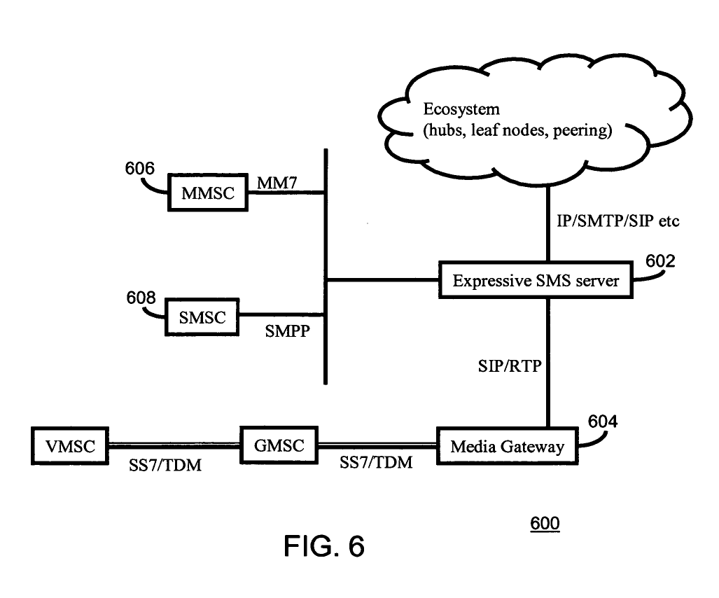

FIG. 6 is sample architecture 600 of the system for creating and sending an expressive message, in accordance with an embodiment of the present invention. The sample architecture 600 consists of expressive SMS server 602, a Media Gateway 604, SMSC 606, MMSC 608 and the Operator Switch Infrastructures. The expressive SMS server 602 will have IP interface to SMSC 606, MMSC 608 and Media Gateway 604. The Media Gateway 604 will support SS7/SIP signaling conversion as well as TDM/Video to RTP conversion.

The SMSC 606 and MMSC 608 will generally be hosted in an operator's environment. The expressive SMS server 602 and Media Gateway 604 can be hosted in an ecosystem or hosted in an operator environment but connected to an ecosystem or hosted stand-alone in an operator environment. The Media Gateway 604 will connect to operator's TDM switch network via SS7 and TDM interfaces. The operator will configure the switches to route calls on a called number with a special prefix to the connecting Media Gateway 604. In the present embodiment, the special prefix is called Pv.

The expressive SMS server 602 will finction as a SME for receiving the text SMS from the sender. The sender sends a SMS to the address prefix-recipient number. The prefix (In the present embodiment, the prefix is called Ps) indicates the SME address of the expressive SMS service. The operator's SMSC 606 will route the message destined to a number prefixed with Ps (and Pv and Po) to the expressive SMS server 602.

All the prefixes such as Ps, Ps2, Pv, Po etc are configurable and definable by individual operators. These prefixes can also share the same prefixes themselves so that when switch or SMSC 606 saw numbers with these same prefixes, they simply through them to the expressive SMS server 602.

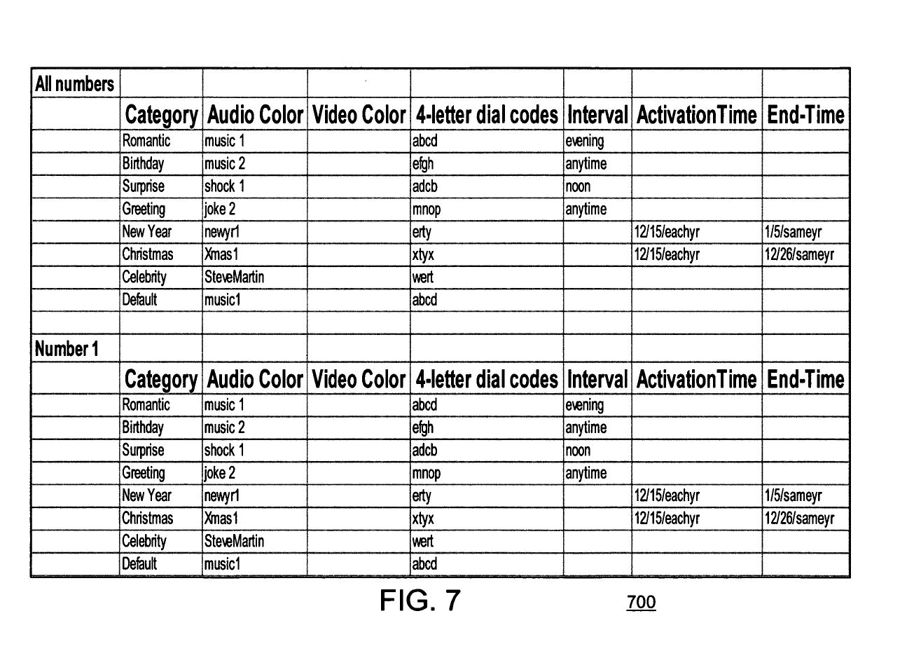

FIG. 7 is sample screen 700 of a portal for personalizing the multimedia content of an expressive message, in accordance with an embodiment of the present invention. The personalized expression or multimedia content preference for a subscriber is defined via a web portal. It can be defined per category or per recipient. In an embodiment of the present invention, it can also be activated based on interval (For example evening only for romantic music) and activation time (close to New Year time for New Year music) and end time (For example just after Christmas for Christmas music). In another embodiment of the present invention, it can also be personalized to individual recipient number. Each type of multimedia content or personalized expression is also indicated by a N dial-able letter (In the present invention, the N dial-able letter is called Nd). The N dial-able letter can follow Ps, for example, Christmas a short code for Christmas music.

The dial sequence for a recipient number of an expressive SMS will be Ps-Nd-recipient number. If the default multimedia content or expression is used, then a different prefix (In the present embodiment, the different prefix is called Ps2) can be used, for example Ps2-recipientNumber.

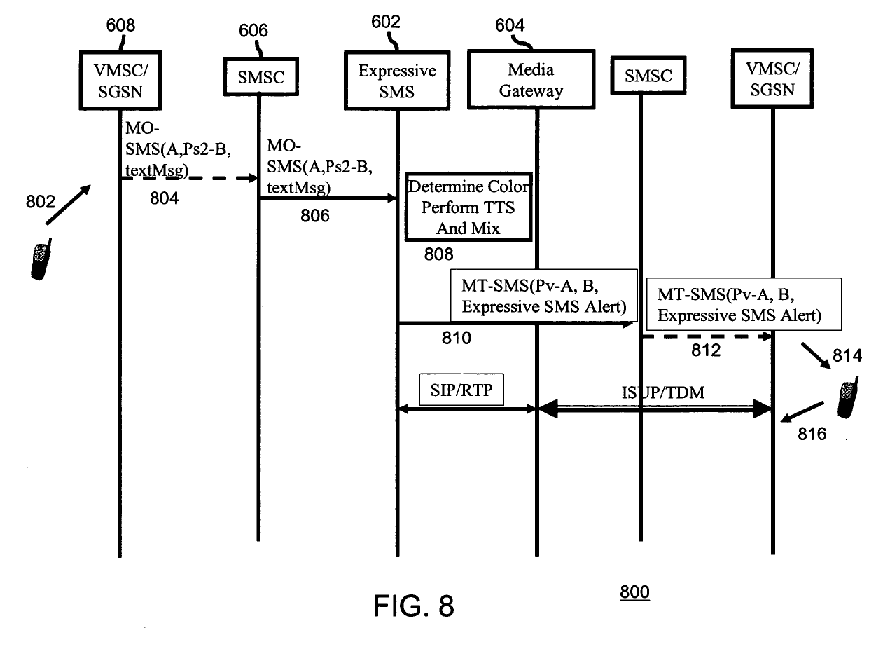

FIG. 8 is sample flow 800 of call for creating and sending an expressive message, in accordance with an embodiment of the present invention. At step 802, a sender A sends the message to Ps2-B via VMSC/SGSN using the first communication device 102. At step 804, the VMSC/SGSN sends the message to SMSC via SS7 (MAP MO-SMS). At step 806, SMSC routes the message via SMPP or other IP protocols (For example CIMD) to expressive SMS.

At step 808, expressive SMS server 602 analyzes the recipient number prefix to determine if it is a default multimedia content selection or preset multimedia content. If it is a preset multimedia content prefix, Expressive SMS server 602 extracts the multimedia content from Nd digits. If it is a default multimedia content selection (for example, using Ps2 prefix), expressive SMS server 602 applies natural language or keywords analysis to determine the context and category of the text and then locates the corresponding multimedia content set for the category at the time for the destination number. It then applies selected voice base at subscription time to convert the SMS text to speech and then mixes the multimedia content with the converted speech.

At step 810, expressive SMS server 602 then sends a SMS alert to the recipient number via a SMSC 606 with the sender number prefixed with Pv. The alert indicates it is an expressive SMS alert for listening or watching. The sender number of the message should still trigger the phone book name if it is defined there because phone book entry is matched with the tail part of the caller ID (or sender number). At step 812, SMSC sends the alert to the recipient switch. At step 814, the recipient switch sends the alert to the recipient handset. At step 816, the recipient can then just return call to the message to listen or watch the video. The set up is made via Media Gateway 604 SS7/SIP signal conversion and TDM/RTP media conversion.

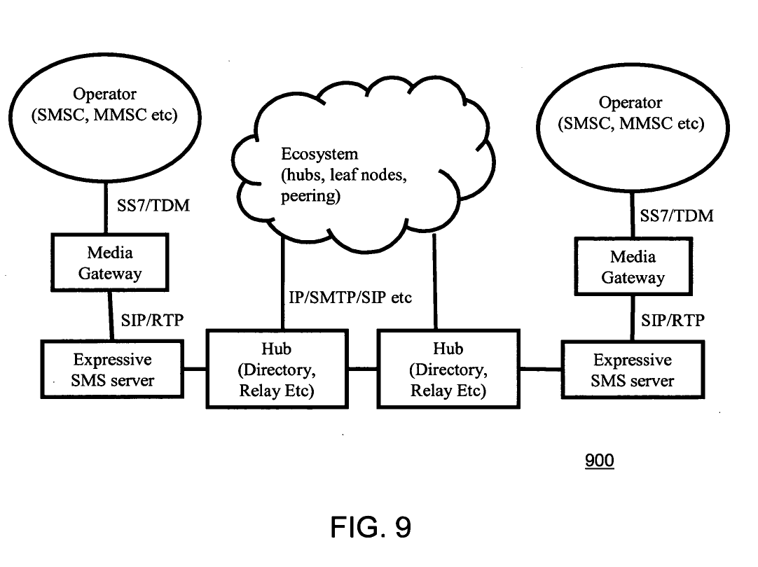

FIG. 9 is sample ecosystem architecture 900 of the system for creating and sending an expressive message, in accordance with an embodiment of the present invention. A sender of an operator on an ecosystem can send an expressive SMS to a recipient at another operator connected to the ecosystem. The ecosystem consists of leaf nodes and hubs in disbursed locations. In a preferred embodiment, those leaf nodes would be situated in the same region as the operators that it serves. The hub will consist of directory services and relay services.

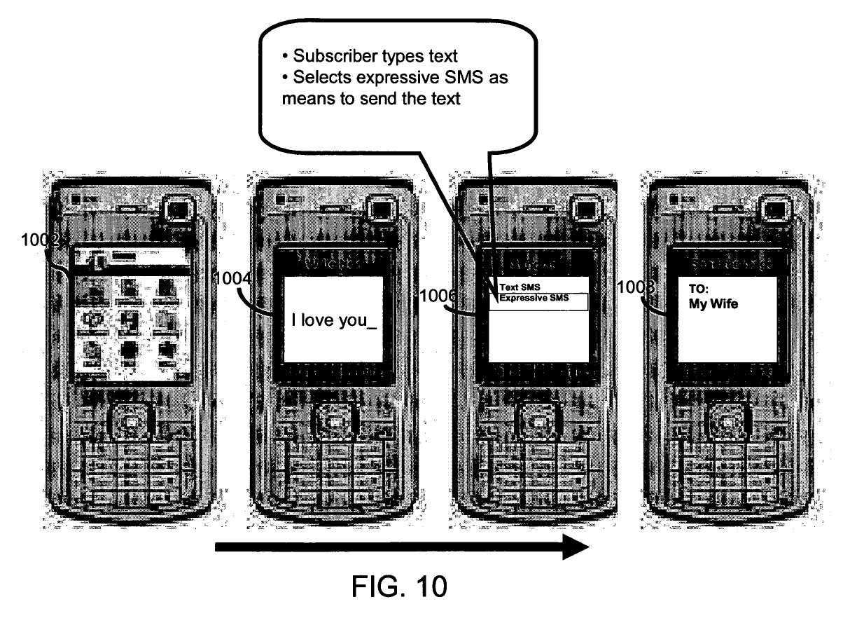

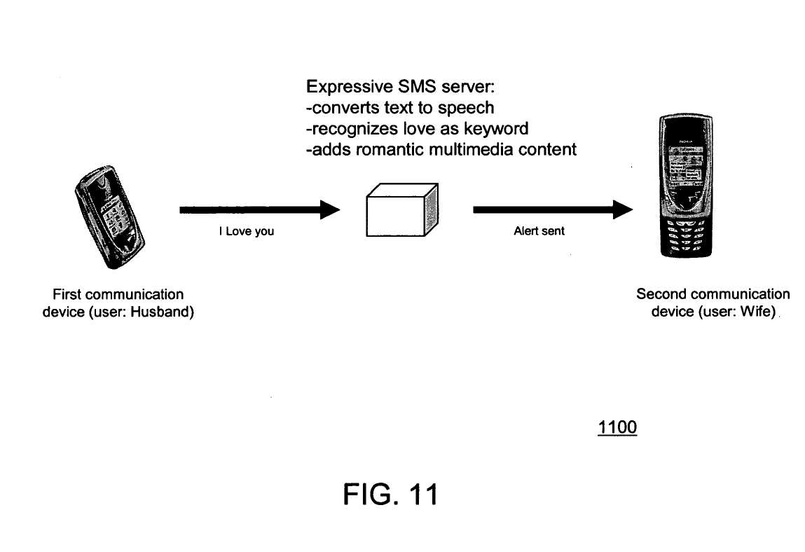

FIG. 10 and FIG. 11 is an example for creating and sending an expressive message from a first communication device 102 to a second communication device 104, in accordance with an embodiment of the present invention. The user of the first communication device 102 sends an expressive message to his wife, who uses the second communication device 104, in accordance with an embodiment of the present invention. FIG. 10 illustrates a sample User Interface (UI) of the first communication device 102. The screen 1002 of the first communication device shows that the user can send his message just like a normal text message. The screen 1004 shows that the user types text ‘I love you’ and goes ahead to send the message. The screen 1006 shows that before sending the message, the user is provided with an option of sending the message text SMS as well as an expressive SMS. The user selects the option if sending the message as an expressive SMS. Finally, the screen 1008 shows that the wife of the user has been selected as a recipient of the expressive SMS. FIG. 11 illustrates how the expressive SMS from the user reaches his wife. The expressive SMS server converts the text ‘I love you’ into speech. It recognized ‘love’ as the keyword and adds romantic audio, video or interactive multimedia content to it. In this example, audio content, video content, and interactive multimedia content are added to the expressive SMS. Further, an alert is sent to the second communication device 104, that an expressive SMS has been received. The alert also contains a pre-specified number through which the expressive message can be accessed. The wife can then call that pre-specified number. When the wife calls the pre-specified number, the expressive SMS server checks whether the second communication device 104 is 2G compatible or 3G compatible. If the second communication device 104 is 2G compatible, the expressive SMS audible speech and other audio content (like romantic music) is played to the wife, who can then listen to the expressive SMS. If the second communication device 104 is 3G compatible, the expressive SMS with video multimedia content is played to the wife, who can then watch and listen to the expressive SMS. In that 3G example, the expressive message can include interactive multimedia content, for example, permitting the romantic music to start as sad music, and then when the wife answers a question “Do you still love me?“, it changes to happy music. Note that in this example, the sender-husband might have only a primitive handset capable of sending a text message, but he has managed to send his wife a message containing many higher forms of media amenable only to a 3G handset. In the alternative, even if the wife has only a fixed-line phone which cannot even receive a text message, she still would hear an expressive message composed of audible speech and other audio content.

In the manner described above, expressive messages can serve the purpose of MMS messages without being limited to MMS capable handsets. Also, expressive messages can be sent to wired phones, which are not capable of receiving SMS messages.

A leaf node can ask directory service of a connecting hub to find out support for a destination operator or country. If supported, the leaf node can send the message to the hub, which relays the message to the destination leaf node serving the destination number.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

The examples under the present invention, detailed in the illustrative examples contained here, are described using terms and constructs drawn largely from GSM mobile telephony infrastructure. However, use of these examples should not be interpreted to limiting the invention to those media. The capabilities of the visited or non-accustomed network can be of use and provided through any type of telecommunications medium, including without limitation: (i) any mobile telephony network including, without limitation, GSM, 3GSM, 3G, CDMA, WCDMA or GPRS, satellite phones or other mobile telephone networks or systems; (ii) any so-called WiFi apparatus normally used in a home or subscribed network, but also configured for use on a visited or non-home or non-accustomed network, including apparatus not dedicated to telecommunications such as personal computers, Palm-type or Windows Mobile devices; (iii) an entertainment console platform such as Sony Playstation, PSP or other apparatus that are capable of sending and receiving telecommunications over home or non-home networks, or even (iv) fixed-line devices made for receiving communications, but capable of deployment in numerous locations while preserving a persistent subscriber id such as the eye2eye devices from Dlink; or telecommunications equipment meant for voice over IP communications such as those provided by Vonage or Packet 8.

### TERMINOLOGY

GMSC: Gateway MSC

ISUP: ISDN User Part

MMSC: Multimedia Message Service Center

MO: Mobile Originated

MSC: Mobile Switch Center

MT: Mobile Terminated

RTP: Real-time Transport Protocol

SIP: Session Initiation Protocol

SMPP: Short Message Peer to Peer Protocol

SMSC: Short Message Service Center

SMTP: Simple Mail Transfer Protocol

SS7: Signaling System 7

TDM: Time-division multiplexing

VMSC: Visit Mobile Switch Center

VMSC-V: VMSC from VPMN

What is claimed is:

1. A method for creating and sending one or more expressive messages, an expressive message being a message containing multimedia content, where the multimedia content includes one or more of audio content, video content and audio-video content, the method comprising:
a) receiving a text message, the text message being a message containing text content, wherein the text message is sent by a first communication device to a second communication device;
b) transforming the text message into an expressive message; and
c) directing the expressive message to the second communication device.

2. The method as recited in claim 1, wherein transforming the text message comprises changing the text content of the text message into speech.

3. The method as recited in claim 2, wherein transforming the text message further comprises adding audio content to the text message, where the audio content includes one or more of music background, celebrity voice and sound effects.

4. The method as recited in claim 2, wherein transforming the text message further comprises adding video content to the text message, where the video content includes one or more of video background, audio-visual background, pictures and video clips.

5. The method as recited in claim 1, wherein transforming the text message comprises at least one of transforming the text message automatically and transforming the text message based on the instructions from the first communication device.

6. The method as recited in claim 1, wherein transforming the text message comprises sending a first notification to the first communication device when the text message gets transformed.

7. The method as recited in claim 1, wherein directing the expressive message comprises contacting the second communication device, where the second communication device can be contacted by least one of:
a) sending an alert to the second communication device, where the alert provides information to the second communication device about the expressive message; and
b) calling directly the second communication device;

8. The method as recited in claim 7, wherein directing the expressive further comprises receiving a request from the second communication device to access the expressive.

9. The method as recited in claim 8, wherein directing the expressive further comprises playing the expressive message to the second communication device on receiving the request.

10. The method as recited in claim 9, wherein playing the expressive message comprises playing the expressive message with the multimedia content compatible with wireless telephone technology used by the second communication device, where the wireless telephone technology is one of 2G technology, 2.5G technology, 3G technology and 4G technology.

11. The method as recited in claim 1, wherein directing the expressive message comprises sending a second notification to the first communication device when the expressive message gets directed to the second communication device.

12. The method as recited in claim 1 further comprising sending the text message to the second communication device, where the text message is sent in original format.

13. A system for creating and sending one or more expressive messages, an expressive message being a message containing multimedia content, the system comprising:
a) a reception module for receiving a text message, the text message being a message containing text content, wherein the text message is sent by a first communication device to a second communication device;
b) a transformation module for transforming the text message into an expressive message, where the expressive message is at least one of an audio expressive message and a video expressive message; and
c) a direction module for directing the expressive message to the second communication device.

14. The system as recited in claim 13, wherein the transformation module comprises a conversion module for changing the text content of the text message into speech.

15. The system as recited in claim 14, wherein the transformation module further comprises an audio mixer module for adding audio content to the text message, where the audio content includes one or more of music background, celebrity voice and sound effects.

16. The system as recited in claim 14, wherein the transformation module further comprises a video mixer module for adding video content to the text message, where the video content includes one or more of video background, video background with music, pictures and video clips.

17. The system as recited in claim 13, wherein the transformation module comprises at least one of means for transforming the text message automatically and means for transforming the text message based on the instructions from the first communication device.

18. The system as recited in claim 13, wherein the transformation module comprises a first notification module for sending a first notification to the first communication device when the text message gets transformed.

19. The system as recited in claim 13, wherein the direction module comprises a contact module for contacting the second communication device.

20. The system as recited in claim 19, wherein the contact module comprises at least one of:
a) an alert module for sending an alert to the second communication device, where the alert provides information to the second communication device about the expressive message; and
b) a caller module for calling directly the second communication device

21. The system as recited in claim 19, wherein the direction module further comprises a request reception module for receiving a request from the second communication device to access the expressive message.

22. The system as recited in claim 21, wherein the direction module further comprises a player module for playing the expressive message to the second communication device on receiving the request.

23. The system as recited in claim 22, wherein the player module comprises a technology detection module for playing the expressive message with the multimedia content compatible with wireless telephone technology used by the second communication device, where the wireless telephone technology is one of 2G technology, 2.5G technology, 3G technology and 4G technology.

24. The system as recited in claim 13, wherein the direction module comprises a second notification module for sending notification to the first communication device when the expressive message gets directed to the second communication device.

25. The system as recited in claim 13 further comprising a text module for sending the text message to the second communication device, where the text message is sent in original format.
